(19) United States
(12) Patent Application Publication
(10) Pub. No.: US 2008/0003048 A1
(43) Pub. Date: Jan. 3, 2008

(54) Dentifrice-Dispensing Toothbrush

(76) Inventors: Karen Glassman, New York, NY (US); Stephan Copeland, Merion Station, PA (US)

Correspondence Address: Brian M. Dingman;Mirick, O'Connell, DeMallie & Lougee, LLP, 1700 West Park Drive, Westborough, MA, 01581, US

(21) Appl. No.: 11/761,414

(22) Filed: Jun. 12, 2007

Related U.S. Application Data
(60) Provisional application No. 60/804,612, filed on Jun. 13, 2006.

(51) Int. Cl. B43K 5/04; A47L 13/22

(52) U.S. Cl. 401/163; 401/158; 401/270

(57) ABSTRACT

A dentifrice-dispensing toothbrush having a handle defining a cavity that is at least partially open at one end of the handle, a dentifrice cartridge located in the cavity and defining an opening located proximate the cavity opening, the opening closed with a cap or temporary seal. There is a head carrying brushing bristles and adapted to be removably engaged with the handle at the cavity opening. The cartridge is fluidly connected to and so delivers dentifrice to the bristles. A roller located in the handle cavity is manually moved to compress the cartridge and so dispense dentifrice; the roller is moved through a roller actuator mechanism coupled to the roller and extending outwardly from the handle.

### CROSS-REFERENCE TO RELATED APPLICATION

This application claims priority of Provisional application Ser. No. 60/804,612, filed on Jun. 13, 2006, the disclosure of which is incorporated herein by reference.

### FIELD OF THE INVENTION

This invention relates to a toothbrush that carries and dispenses dentifrice.

### BACKGROUND OF THE INVENTION

Conventional toothbrushes include an elongated handle and a brush having a plurality of bristles. Typically, a paste, gel, or some other suitable dentifrice is stored in a separate container and is dispensed by a user onto the bristles for brushing the user's teeth. One recognized way to prevent tooth decay and periodontal disease is through regular brushing of teeth and gums. Tooth decay results when the bacteria in plaque feed on carbohydrates (sugar and starch) in the user's diet to produce acids. Brushing removes decay-causing plaque and other contaminants from the tooth surfaces, and freshens breath.

The American Dental Association (ADA) recommends that people brush their teeth twice a day with a fluoride dentifrice for good oral hygiene. Good oral hygiene also requires that the brush be replaced periodically in order to maintain the effectiveness of the toothbrush for cleaning. The bristles need to be flexible and soft so that they do not damage the gums and teeth during brushing. The bristles eventually become worn and/or damaged (broken, bent, frayed, etc.) as a result of repeated brushing. The ADA recommends that people replace a toothbrush every three or four months, or sooner if the bristles become worn and/or damaged. A damaged or worn toothbrush will not do a good job of cleaning teeth. In addition, microbes can grow on toothbrush bristles and the brush head. Although most microbes are harmless, others can be harmful, such as the cold and flu viruses, the herpes virus that causes cold sores, and bacteria that can cause periodontal infections.

Conventional toothbrush systems typically require a separate container for the storage and dispensing of dentifrice. Common types of dentifrice materials include powders, pastes, gels, and liquids. Separate dentifrice containers typically have caps that can become lost and/or contaminated. Dentifrice may also be inadvertently discharged from these separate containers causing a mess on sinks, cabinets, counters, travel containers, cosmetic cases and suitcases. People without access to running water (such as those in the military) would find useful a system that incorporated the dentifrice into the toothbrush so that they did not need to carry and hold a dentifrice tube along with their toothbrush and a bottle of water for rinsing the mouth. In addition, the use of separate containers for holding the toothpaste or gel may also lead to other sanitary problems. For example, the dispensing opening of the separate container can also become contaminated in the bathroom environment and during packing for travel. Furthermore, when multiple users share a single dentifrice container, there can be cross-contamination of the individual toothbrushes when the dispensing opening of the separate container touches the bristles of the toothbrushes of different users.

Another problem with conventional toothbrush systems is that the handle is typically discarded along with the entire toothbrush system because the brush portion has failed. This is true even though the handle is typically still in good working condition. The handle portion is very durable and typically outlasts the useful life of the brush and the supply of dentifrice in the separate dentifrice container. It would be desirable to reuse the portions of the toothbrush system that are still in good working condition.

Certain users, such as the elderly, arthritis sufferers, and children, have difficulty in manually dispensing dentifrice from a tube. Such users may find it desirable to have a toothbrush system having an automatic dispensing system for applying the dentifrice on the brush. Some users also find automatic brushing systems for vibrating, rotating, and/or oscillating the brush to be desirable. But these automatic dispensing systems and/or automatic brushing systems add a signification portion to the overall cost of the dentifrice system and therefore it is desirable to reuse the automatic dispensing system.

A need exists for a toothbrush system that solves one or more of the above-identified problems.

### SUMMARY OF THE INVENTION

This invention comprises a toothbrush that integrates dentifrice storage and dispensing into the handle of the toothbrush. This creates an improved tooth brushing procedure, as the user does not have to handle and apply dentifrice from a tube. The process of dispensing paste directly from the brush's handle is quicker, cleaner, and easier.

The invention also gives the user more convenient traveling scenarios, for example being able to brush teeth at work without having to carry a toothbrush and a tube of dentifrice into the bathroom. Since there is a designated toothbrush and cartridge of dentifrice for each user, the inventive toothbrush helps eliminate the spreading of germs, compared to the conventional sharing of a tube of dentifrice.

This invention features a dentifrice-dispensing toothbrush having a handle defining a cavity that is at least partially open at one end of the handle, a dentifrice cartridge located in the cavity and defining an opening located proximate the cavity opening, the opening closed with a temporary seal, a head carrying brushing bristles and adapted to be removably engaged with the handle at the cavity opening, a tube running through the head and defining a tube handle end that fluidly connects to the cartridge opening when the head is engaged with the handle, and a tube dispensing end that delivers dentifrice to the bristles, a roller located in the handle cavity so as to compress the cartridge as the roller is moved, and a roller actuator mechanism coupled to the roller and extending outwardly from the handle, to allow the user to move the roller toward the head in order to compress the cartridge and dispense dentifrice through the head to the bristles.

The passage may comprise a tube, and the temporary closure may comprise a seal. The tube may be adapted to pierce the cartridge seal. The cartridge may define a projecting tube that passes through the handle opening. The projecting tube may be closed with a removable cap. The handle may comprise a clamshell construction. The handle may comprise an internal post spaced from the handle opening, and the cartridge may define an opening that is adapted to fit over the handle post, to maintain the cartridge in place as the dentifrice is dispensed.

The head may define a first section that fits within the handle cavity, and a second section that projects from the cavity through the handle opening, and a narrowed groove located between the first and second sections that is adapted to engage with the handle adjacent to its cavity opening. The handle may define an elongated slot through which the roller actuator mechanism passes. There may be an elongated gasket that fits into the slot.

The invention also features a dentifrice-dispensing toothbrush, comprising a handle defining a cavity that is at least partially open at one end of the handle, and an internal post located in the cavity and spaced from the handle opening, a head carrying brushing bristles and adapted to be removably engaged with the handle at the cavity opening and defining a first section that fits within the handle cavity, a second section that projects from the cavity through the handle opening, and a narrowed groove located between the first and second sections that is adapted to engage with the handle adjacent to its cavity opening, a dentifrice cartridge for placement in the cavity, and defining an outlet that is located proximate the cavity opening or in the head when the cartridge is placed in the handle, the outlet closed with a temporary closure, the cartridge further defining an opening that is adapted to fit over the handle post, to maintain the cartridge in place as the dentifrice is dispensed, a passage running through the head and defining a passage handle end that fluidly connects to the cartridge outlet when the head is engaged with the handle, and a passage dispensing end that delivers dentifrice to the bristles, a roller located in the handle cavity so as to compress the cartridge as the roller is moved, and a roller actuator mechanism coupled to the roller and extending outwardly from the handle, to allow the user to move the roller toward the head in order to compress the cartridge and dispense dentifrice to the bristles. The cartridge may define a projecting tube that passes through the handle opening. The projecting tube may be closed with a removable cap. The handle may comprise a clamshell construction.

In a more specific embodiment, the invention features a dentifrice-dispensing toothbrush, comprising a handle defining a cavity that is at least partially open at one end of the handle and is adapted to hold a dentifrice cartridge, a head carrying brushing bristles and adapted to be removably engaged with the handle at the cavity opening, a passage running through the head and defining a passage handle end that fluidly connects to the handle cavity when the head is engaged with the handle, and a passage dispensing end that is adapted to deliver dentifrice to the bristles, a roller located in the handle cavity so as to compress a dentifrice cartridge located in the cavity as the roller is moved, and a roller actuator mechanism coupled to the roller and extending outwardly from the handle, to allow the user to move the roller toward the head in order to compress the cartridge and dispense dentifrice to the bristles.

The invention also features a dentifrice cartridge, comprising a deformable container containing dentifrice and constructed so that it can be flattened, a narrow, elongated dispensing tube projecting from the container at one end thereof and defining at its distal end a dentifrice-dispensing opening, a structure for closing the dentifrice-dispensing opening of the dispensing tube, and a flat section projecting from the container and located opposite the tube, the flat section defining an opening that is adapted to fit over a post. The junction of the flat section and the container may define a shoulder that is adapted to be engaged with a roller that can be moved along the container to dispense dentifrice from the dispensing tube opening.

### BRIEF DESCRIPTION OF THE DRAWINGS

Objects, features and advantages will occur to those skilled in the art from the following detailed description of the invention, and the accompanying drawings, in which:

FIG. 1 shows each of the components of one embodiment of the inventive toothbrush;

FIG. 2 is a side view of the assembled toothbrush of FIG. 1;

FIG. 3 shows the wheel assembly as it compresses the dentifrice cartridge of the toothbrush of FIGS. 1 and 2;

FIGS. 4A, 4B and 4C are three sectional views showing the progression of the wheel assembly as the dentifrice cartridge is emptied;

FIG. 5 is a perspective cut away view of the toothbrush of FIGS. 1-4;

FIG. 6 shows the rubber gasket forming a seal around the wheel holding bracket as it moves towards the head;

FIG. 7 is a disassembled view of another embodiment of the invention that can use a standard dentifrice tube;

FIG. 8 shows another embodiment of the invention;

FIG. 9 is a disassembled view of the embodiment of FIG. 8; and

FIG. 10 shows the preferred dentifrice tube or cartridge for the invention, that is adapted to be used with the embodiment shown in FIGS. 8 and 9.

### DETAILED DESCRIPTION OF THE INVENTION

In the preferred embodiment, the inventive toothbrush has a hollow main body or handle that holds a dentifrice cartridge. A separate head is designed to engage with the handle and carries the bristles. The head has an integral tube or cavity that carries dentifrice to the bristles. The dentifrice cartridge has a small opening that is closed by a seal or cap. The cartridge is placed such that the head engages with the cartridge opening when the head is engaged with the main body. A hand-operated roller assembly forces dentifrice from the cartridge, through the head and to the bristles.

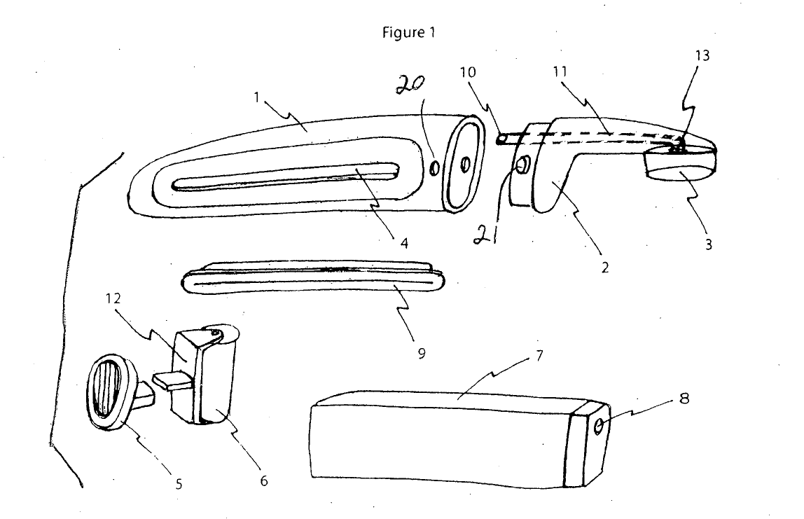

The component parts of one embodiment of the invention are shown in FIG. 1. The assembly starts with engaging a rubber gasket 9 into a slot or track 4 in main body or handle 1. Compression wheel 6 is attached to wheel holding bracket 12. Compression wheel 6 and wheel holding bracket 12 are slid inside main body 1 with the bracket projection located in track 4. Actuator button 5 is snapped onto the projection of wheel-holding bracket 12, locking the compression wheel assembly to main body 1. Dentifrice cartridge 7 is then inserted into main body 1 with access hole 8 at the open end. The cartridge may have a locating hole near its end that is distant from the access hole, with a mating post in the handle protruding into the cavity behind the rearmost location of the roller. See FIG. 10. When present, this hole is placed over the post when the cartridge is placed in the handle. This properly locates the cartridge in the handle, and also prevents the cartridge from being pushed toward the head when the roller engages the cartridge, so that the roller will successfully compress the cartridge rather than pushing the full cartridge up against the head end of the handle. When head 2 is pressed onto and snapped onto main body 1, the seal over access hole 8 is punctured by cartridge-puncturing tube 10. Tube 10 then connects cartridge 7 to dentifrice tube/conduit 11.

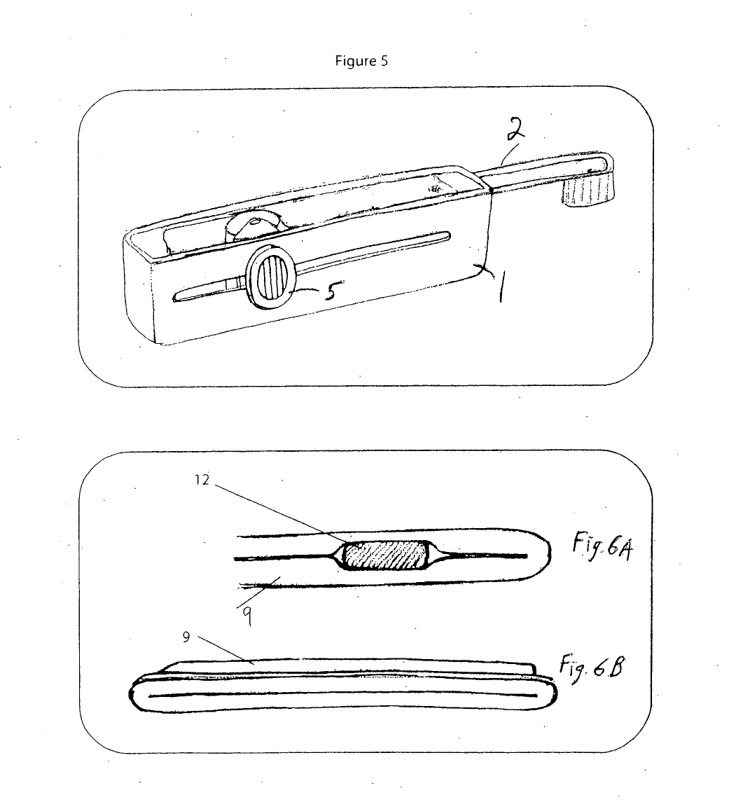

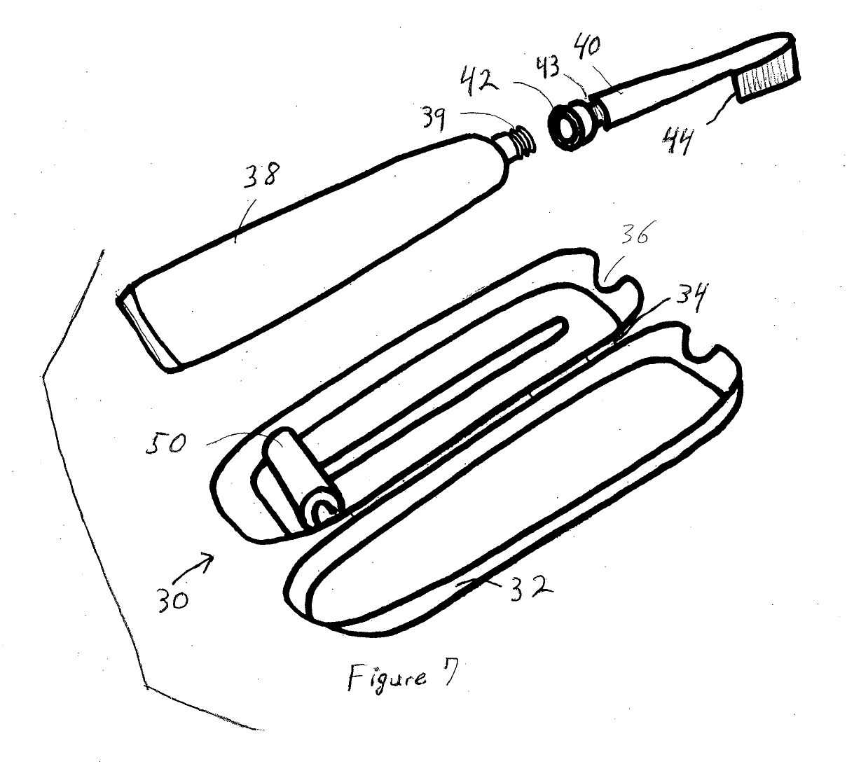

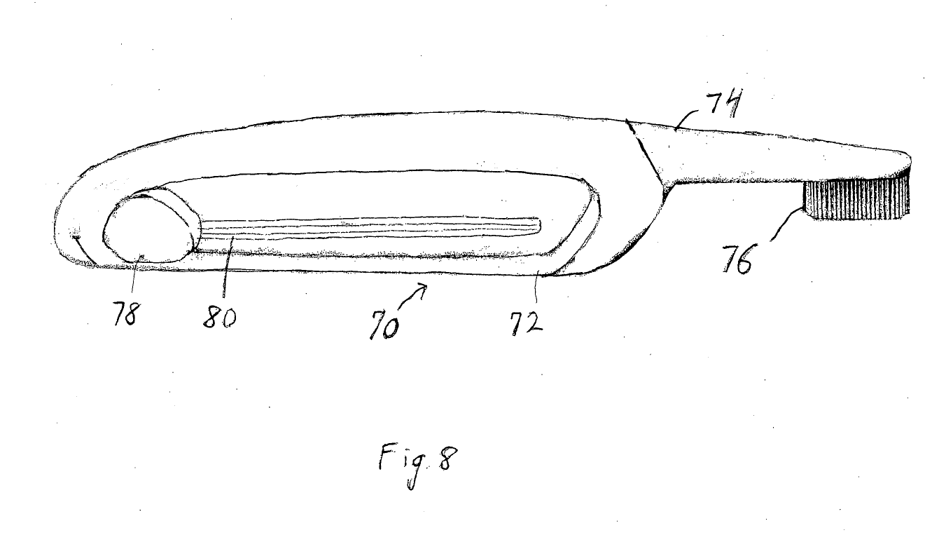

Once the product is assembled, the user advances tube compression wheel 6 by pushing actuator button 5 toward the head along track 4 on the side of main body 1. Compression wheel 6 compresses dentifrice cartridge 7 and forces dentifrice out of cartridge 7 through conduit 11 to aperture 13 at bristles 3. FIGS. 4A-4C comprise sectional views showing the progression as cartridge 7 is emptied. FIG. 5 is a perspective cut away view of the assembly. FIG. 6 shows rubber gasket 9 forming a seal around wheel holding bracket 12 as it moves towards head 2. This seal inhibits water from entering main body 1 and provides a more finished appearance.

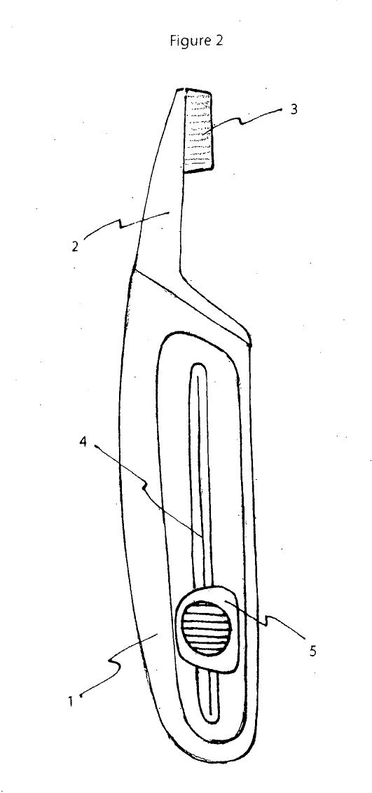

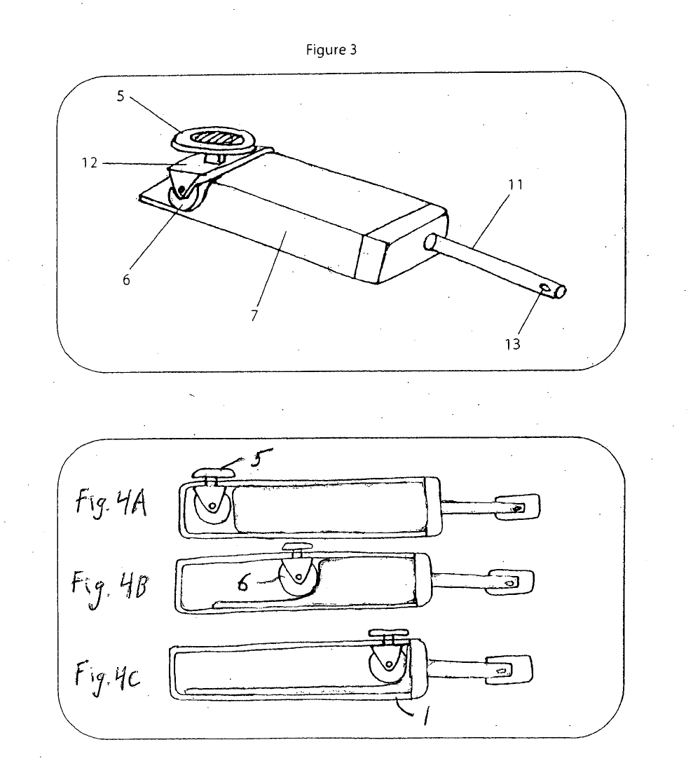

The embodiment shown in FIGS. 1-6 can be used as follows: The user picks up the unit by main body 1 with one hand, and slides actuator button 5 in the direction of head 2 until the desired amount of dentifrice is visible in bristles 3. By doing this, dentifrice is delivered to bristles 3, and the user can brush as normal.

FIG. 7 shows one potential construction of alternative embodiment 30 with handle 32 that can be a molded plastic body comprising two pieces, or one piece with two halves (i.e., a clamshell design) connected by a living hinge 34 that are snapped together with interfitting engaging portions (not shown), and/or held together with one or more screws or other simple fastener(s) that allow dentifrice cartridge 38 to be easily changed by the user. This drawing also shows that dentifrice cartridge 38 can be an off-the-shelf tube with a screw-type engagement portion on neck 39. Head 40 with bristles 44 can be designed with mating threaded female section 42 that engages with threaded neck 39, and may have narrowed groove 43 that sits in handle opening 36 and engages with body 32 to maintain a tight fit between the head and the body. Roller 50 operates in the same manner as the roller in the first described embodiment.

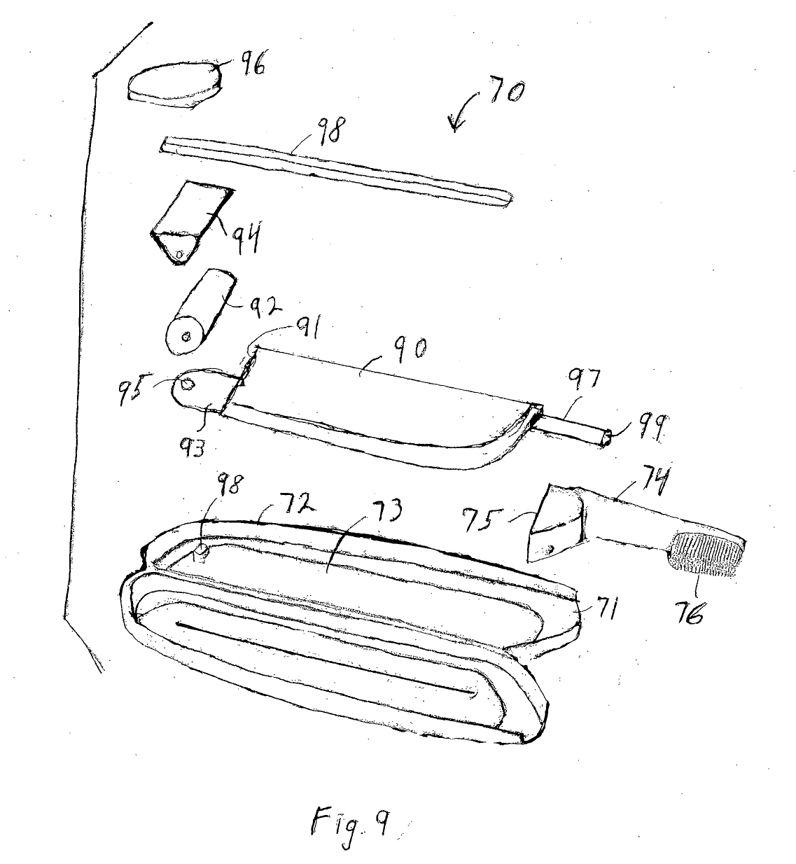

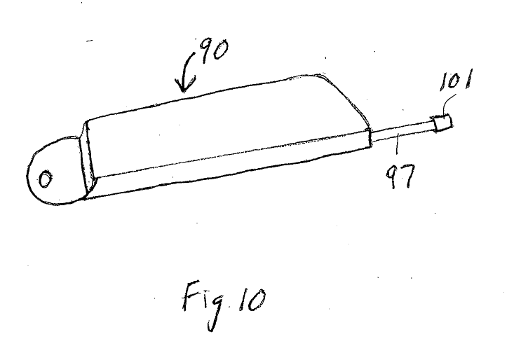

FIGS. 8-10 show another embodiment in which the custom dentifrice cartridge defines a projecting tube that fits into the disposable head. Inventive toothbrush 70 has clamshell main body/handle 72 that carries track 80 that guides tube compression thumbwheel 78 that fits within cavity 72. Head 74 has enlarged portion 75 that fits into the portion of handle 72 proximate its opening 71. Dentifrice cartridge 90 includes integral projecting dispensing tube 97 with opening 99 that is closed by a seal, or by removable cap 101 or a similar removable or puncturable seal. Tube 97 fits into head 74 and leads to an integral cavity or tube in the head that leads to the base of bristles 76. The manner in which dentifrice is fed into the base of the bristles is known in the art.

Roller 92 is initially located just behind tube shoulder 91, on flat extension 93 that defines hole 95. Hole 95 is received over projecting post 98 to hold cartridge 90 in place as the dentifrice is dispensed. Hole 95 also provides a convenient means for retail display of tube 90 on the ubiquitous wire pegs used to hang packaged items at retail. Roller 92 is pushed by means of thumbwheel 96 and wheel-holding bracket 94. Gasket 98 can be located in track 80. The dentifrice located in tube 90 is forced through exit tube 97 into head 74 to bristles 76.

This embodiment can be accomplished with simple injection molded handle and head. After-market retail sales may comprise one dentifrice cartridge 90, or perhaps two or more cartridges packaged with a replacement head 74. These choices allow the user to replace the brush as needed by buying a new head, or a retail pack with dentifrice cartridges(s) and a replacement head.

Although specific features of the invention are shown in some drawings and not others, this is for convenience only as the features may be combined in accordance with the invention. Other embodiments will occur to those skilled in the art and are within the following claims.

What is claimed is:

1. A dentifrice-dispensing toothbrush, comprising:
a handle defining a cavity that is at least partially open at one end of the handle;
a head carrying brushing bristles and adapted to be removably engaged with the handle at the cavity opening;
a dentifrice cartridge for placement in the cavity, and defining an outlet that is located proximate the cavity opening or in the head when the cartridge is placed in the handle, the outlet closed with a temporary closure;
a passage running through the head and defining a passage handle end that fluidly connects to the cartridge outlet when the head is engaged with the handle, and a passage dispensing end that delivers dentifrice to the bristles;
a roller located in the handle cavity so as to compress the cartridge as the roller is moved; and
a roller actuator mechanism coupled to the roller and extending outwardly from the handle, to allow the user to move the roller toward the head in order to compress the cartridge and dispense dentifrice to the bristles.

2. The dentifrice-dispensing toothbrush of claim 1 in which the passage comprises a tube.

3. The dentifrice-dispensing toothbrush of claim 2 in which the temporary closure comprises a seal.

4. The dentifrice-dispensing toothbrush of claim 3 in which the tube is adapted to pierce the cartridge seal.

5. The dentifrice-dispensing toothbrush of claim 1 in which the cartridge defines a projecting tube that passes through the handle opening.

6. The dentifrice-dispensing toothbrush of claim 5 in which the projecting tube is closed with a removable cap.

7. The dentifrice-dispensing toothbrush of claim 1 in which the handle comprises a clamshell construction.

8. The dentifrice-dispensing toothbrush of claim 1 in which the handle further comprises an internal post spaced from the handle opening.

9. The dentifrice-dispensing toothbrush of claim 8 in which the cartridge defines an opening that is adapted to fit over the handle post, to maintain the cartridge in place as the dentifrice is dispensed.

10. The dentifrice-dispensing toothbrush of claim 1 in which the head defines a first section that fits within the handle cavity, and a second section that projects from the cavity through the handle opening.

11. The dentifrice-dispensing toothbrush of claim 10 in which the head further defines a narrowed groove located between the first and second sections that is adapted to engage with the handle adjacent to its cavity opening.

12. The dentifrice-dispensing toothbrush of claim 1 in which the handle defines an elongated slot through which the roller actuator mechanism passes.

13. The dentifrice-dispensing toothbrush of claim 12 further comprising an elongated gasket that fits into the slot.

14. A dentifrice-dispensing toothbrush, comprising:
a handle defining a cavity that is at least partially open at one end of the handle, and an internal post located in the cavity and spaced from the handle opening;
a head carrying brushing bristles and adapted to be removably engaged with the handle at the cavity opening and defining a first section that fits within the handle cavity, a second section that projects from the cavity through the handle opening, and a narrowed groove located between the first and second sections that is adapted to engage with the handle adjacent to its cavity opening;
a dentifrice cartridge for placement in the cavity, and defining an outlet that is located proximate the cavity opening or in the head when the cartridge is placed in the handle, the outlet closed with a temporary closure, the cartridge further defining an opening that is adapted to fit over the handle post, to maintain the cartridge in place as the dentifrice is dispensed;
a passage running through the head and defining a passage handle end that fluidly connects to the cartridge outlet when the head is engaged with the handle, and a passage dispensing end that delivers dentifrice to the bristles;
a roller located in the handle cavity so as to compress the cartridge as the roller is moved; and
a roller actuator mechanism coupled to the roller and extending outwardly from the handle, to allow the user to move the roller toward the head in order to compress the cartridge and dispense dentifrice to the bristles.

15. The dentifrice-dispensing toothbrush of claim 14 in which the cartridge defines a projecting tube that passes through the handle opening.

16. The dentifrice-dispensing toothbrush of claim 15 in which the projecting tube is closed with a removable cap.

17. The dentifrice-dispensing toothbrush of claim 14 in which the handle comprises a clamshell construction.

18. A dentifrice-dispensing toothbrush, comprising:
a handle defining a cavity that is at least partially open at one end of the handle and is adapted to hold a dentifrice cartridge;
a head carrying brushing bristles and adapted to be removably engaged with the handle at the cavity opening;
a passage running through the head and defining a passage handle end that fluidly connects to the handle cavity when the head is engaged with the handle, and a passage dispensing end that is adapted to deliver dentifrice to the bristles;
a roller located in the handle cavity so as to compress a dentifrice cartridge located in the cavity as the roller is moved; and
a roller actuator mechanism coupled to the roller and extending outwardly from the handle, to allow the user to move the roller toward the head in order to compress the cartridge and dispense dentifrice to the bristles.

19. A dentifrice cartridge, comprising:
a deformable container containing dentifrice and constructed so that it can be flattened;
a narrow, elongated dispensing tube projecting from the container at one end thereof and defining at its distal end a dentifrice-dispensing opening;
a structure for closing the dentifrice-dispensing opening of the dispensing tube; and
a flat section projecting from the container and located opposite the tube, the flat section defining an opening that is adapted to fit over a post.

20. The dentifrice cartridge of claim 19 in which the junction of the flat section and the container defines a shoulder that is adapted to be engaged with a roller that can be moved along the container to dispense dentifrice from the dispensing tube opening.
